(19) United States
(12) Patent Application Publication
(10) Pub. No.: US 2019/0088050 A1
(43) Pub. Date: Mar. 21, 2019

(54) BARRIER CONTROL SYSTEM

(71) Applicant: Parknet LLC, San Juan, PR (US)

(72) Inventors: Antonio J. Ramos-Guardiola, San Juan, PR (US); Alan Lopez-Garcia, Naguabo, PR (US); Christian M. Rodriguez-Merced, Caguas, PR (US); Gretchen I. Quiles-Ayala, Rio Grande, PR (US)

(73) Assignee: Parknet LLC, San Juan, PR (US)

(21) Appl. No.: 16/135,903

(22) Filed: Sep. 19, 2018

Related U.S. Application Data
(60) Provisional application No. 62/560,225, filed on Sep. 19, 2017.

(51) Int. Cl. G07C 9/00; G06K 9/00

(52) U.S. Cl. CPC G07C 9/00103; G07C 9/00079; G07C 9/00087; G07C 2009/00753; G07C 9/00309; G06K 9/00288; G07C 2009/00468; G07C 9/00563

(57) ABSTRACT

The device controls the opening and closing of mechatronic access control barriers. It validates entry requests from identity verification mechanisms with a real-time database of authorizations. Controlling users can give, remove, and edit virtual entry keys in real-time. Keys are programmed for one-time use, specific amount of uses, or in a fixed or recurring schedule. Potential guests can request in advance a virtual key of a restricted area from controlling users. The device sends an entry notification to controlling users when their virtual keys are used.

### RELATED APPLICATIONS

This application claims priority from U.S. Provisional Patent Application No. 62/560,225, filed on Sep. 19, 2017.

### BACKGROUND OF THE INVENTION

### Field of the Invention

The present invention relates to an electronic barrier control system that can operate automatically and can be remotely configured and monitored. Access to places secured by barriers can be granted by several types of virtual or digital keys that can be configured based on the user to whom access is being granted. Particularly, an embodiment disclosed is a device comprising a processor, memory, transceivers and expansion ports for several sensors. Said sensors are capable of recognizing different types of virtual or digital keys. Said keys are to be distributed to users to access places restricted by barriers under specific circumstances such as identity, time of day, received payment, etc.

### Background of the Invention

Barrier controllers that are currently used in gated or restricted areas are not remotely accessible. Most available barrier controllers rely on human operation and require configuration and setup specific to an operating system. U.S. Pat. No. 6,634,408 discloses a method for automatically operating barriers without human interaction. This prior art helps with the problem of requiring a person to open or close a barrier. However, the barrier system cannot be configured to operate under a specific set of rules and conditions and remotely granting access to certain users, instead only opening or closing the barrier based on distance and other sensors.

Further, U.S. Patent Application 2013/0321127 discloses a system that monitors the status of a barrier so that a user can be sure it is closed even if not seeing it, and so it does not close back again if the user has not reached it. This system still does not help solve the problem that sometimes access to a barrier needs to be limited based on the person to whom access is being granted.

Presently there is no integrated process that allows to remotely configure a network virtual key database and control a barrier actuator via hardware. The present invention seeks to provide a solution to these problems by providing a barrier control system that features remote configurability, network access to databases, validates keys, and physically controls a barrier.

### SUMMARY OF THE INVENTION

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

In light of the shortcomings of the prior art, the present invention generally relates to a barrier control system that comprises interfaces for various kinds of input devices, a database containing and a memory. More specifically, the present invention relates to a standalone system that comprises input sensors, such as imaging devices, to read digital keys, wherein information related to said digital keys is stored in a remote database and can be modified and configured to provide access under certain conditions.

In accordance with the principles of the present disclosure, an exemplary embodiment of the present invention uses a QR code scanner connected through one of the interface ports to receive input when a user presents its digital key. By using digital keys such as QR codes, access can be granted or restricted remotely without need to configure anything physically where the barrier is located. Furthermore, by using a database, information regarding every key is stored, so what kind of access is being given at a particular location can be easily monitored and audited for security purposes.

An object of the present invention is to provide a barrier control system that can be remotely operated.

Another object of the present invention is to provide a barrier control system that operates using digital keys.

Another object of the present invention is to provide a barrier control system that can store information related to every user that is able to access the restricted area.

To enable a better understanding of the objectives and features of the present invention, a brief description of the drawings below will be followed with a detailed description of the invention.

### BRIEF DESCRIPTION OF THE DRAWINGS

Various other objects, features and advantages of the present invention will become fully appreciated as the same becomes better understood when considered in conjunction with the accompanying drawings.

FIG. 1 is a block diagram of the various elements that interact to achieve the objects of the present invention.

FIG. 2 is a block diagram of the various components of an exemplary embodiment of the present invention.

FIG. 3 illustrates further illustrates the various elements that achieve the objects of the present invention in relation to a user being granted access to a restricted area.

### DESCRIPTION OF EXAMPLE EMBODIMENTS

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a memory module” may include a plurality of memory modules unless the context clearly dictates otherwise. As used in the specification and claims, singular names or types referenced include variations within the family of said name unless the context clearly dictates otherwise. Terms such as “attached,” “affixed,” “connected,” “mechanically coupled,” “interconnected,” and similar refer to a relationship wherein structures are secured or attached to one another either directly or indirectly through intervening structures, as well as both movable or rigid attachments or relationships, unless expressly described otherwise. Terms such as “electronically coupled” are directed to wire and wireless connections between electronic elements such as power supplies, amplifiers, computers and circuits. Moreover, the features and benefits of the disclosure are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto. Certain terminology is used in the following description for convenience only and is not limiting.

Turning descriptively into the drawings, in which reference characters denote similar elements, the figures illustrate the exemplary embodiment having a processor, a memory, wireless communication transceivers, several ports and software stored in said memory.

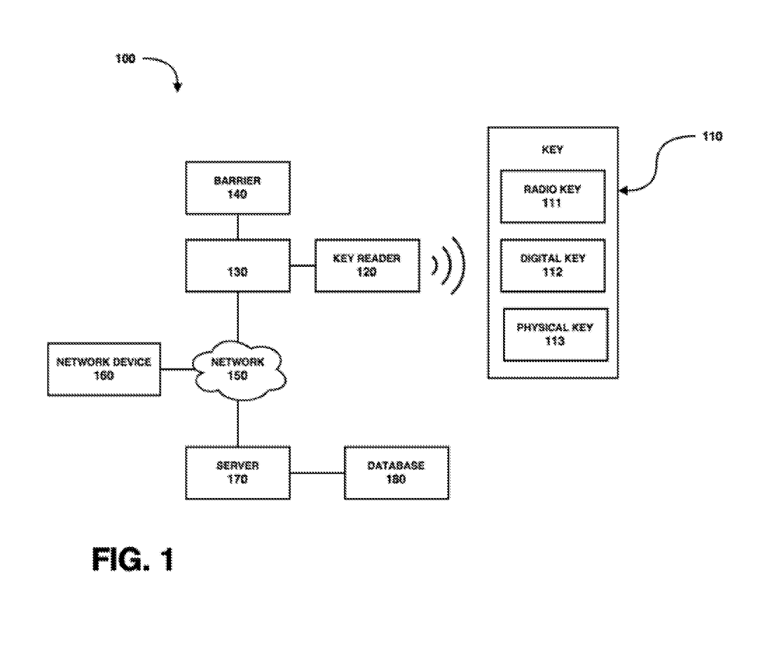

As shown in FIG. 1, and exemplary embodiment of the barrier control system object of the present invention 100 allows controlling users, which are fixed users of a restricted area, to invite other non-fixed users into this restricted area by creating and sending a key 110 unique to this user. A key can be, but is not limited to virtual images like QR codes and Aztec codes 112 which can be presented digitally to a reader 120 from any device 160 with a screen, or algorithms. Controlling users can also enable other types of keys that are fixed to a user to be used as keys for this restricted area with the barrier control system. For example, keys may also be radio wave communication devices 111 such as RFID (Radio Frequency Identification) of NFC (Near-field communication) tags or physical keys 113 that comprise a memory for storing digital information related to a key. A key may also be a digital representation of a user's biometric identification data, such as a fingerprint, facial features, retina, or voice.

Keys are presented to a reader 120 by the visitor, temporary user or controlling user. The reader may be any kind of input device that can recognize and interpret the key data, such as a QR code scanner, a camera, a fingerprint scanner, etc. These input devices are recognized by the barrier control system through a series of interface ports. The reader sends the received input in digital format to the barrier control system 130 which evaluates keys, receives updates of keys and accesses the database 180 from the server 170 through the network 150 to retrieve information about said key, such as user privileges, location information, and other information. The barrier control system then reports interactions to the server 170 and manipulates barriers 140 via the barrier control mechanisms and/or barrier lock mechanisms. Controlling users specify the period of time for which a key they emitted is valid, the date or dates it can be used, the amount of time and receive a notification every time a key emitted by them is used. A front-end for the barrier control system accessible through a web application or a mobile application allows controlling users to request, emit, monitor, edit or cancel keys for the barrier control system.

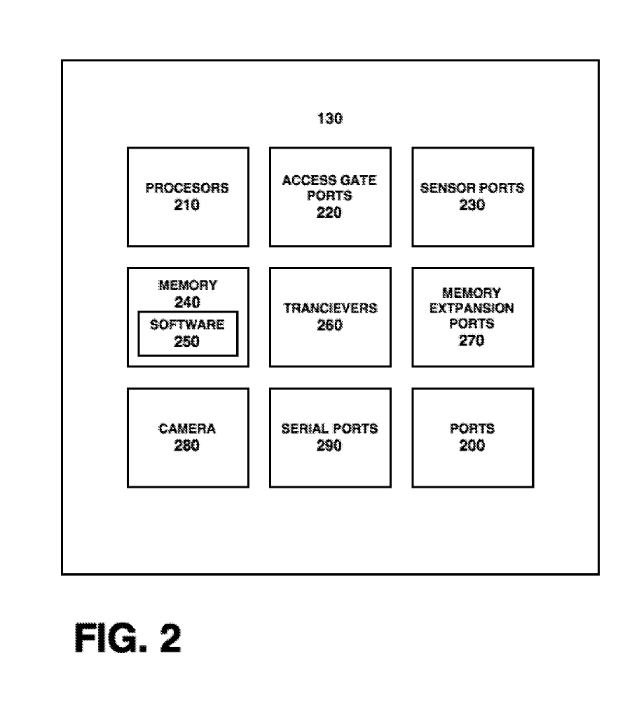

FIG. 2 illustrates the components of an exemplary embodiment 130 of the present invention. This exemplary embodiment comprises one or more processors 210 that manage all the operations of the device, such as obtaining key data from sensors, transferring said data to a database via transceivers 260, and executing the software 250 stored in the memory 240 to change the configuration of the device. The exemplary embodiment further comprises several types of ports to attach devices so key data can be retrieved and existing barrier systems can be connected. Said ports may be UART, USB, or other. Sensor ports 230 allow the present invention to interact with input devices such as barcode scanners, fingerprint scanners, retina scanners, RFID readers, microphones, or any other kind of device that can be used to input data into the system. Said data is then recognized by the processor and compared with a database of emitted keys to grant or deny access based on what the information for that specific key is in the database. Another exemplary embodiment comprises a camera built-into the device for identification and monitoring of users that are being granted or denied access. Access gate ports 220 enable the system to be installed on existing barrier systems.

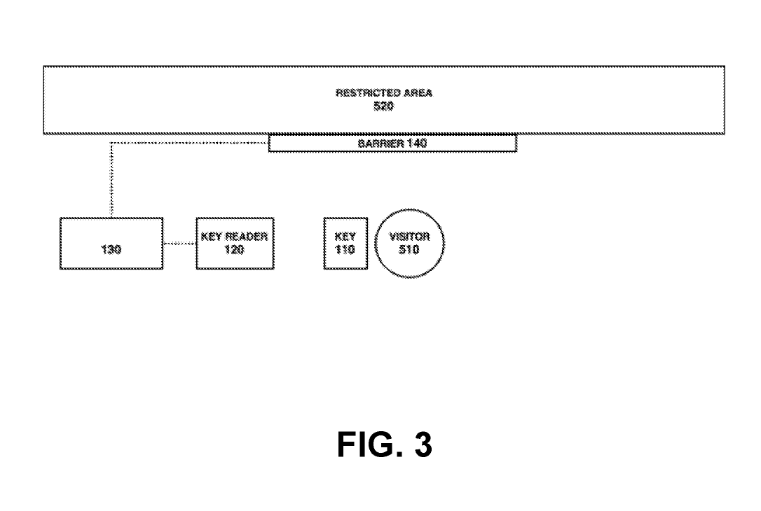

FIG. 3 shows a user 510 that has been given a key 110 by a controlling user interacting with a key reader 120. When showing the key 110 to the reader 120, the digital data from the key will be processed by the barrier control system object of the present invention 130. If the barrier control system determines that the key is valid and the conditions for granting access are met, the barrier 140 will be removed and the user 510 will have access to the restricted area 520. Data from the interaction will be stored in a database so an auditable history of granted access is maintained, for example, visitor 510 entered are 520 using key 110 on Friday, Mar. 8, 2018, at 3:00 pm.

Preferably, the device can be managed remotely from any device with internet browsing capabilities, so no physical access to the system is required to configure it. Preferably, the barrier control system can interact with any barrier, such as but not limited, to magnetic locks, gate barriers and electronic locks. Barrier control mechanisms or existing barrier control systems can also be interacted with. The barrier control system can also interact with any reader, including but not limited to, cameras, radio wave communication devices and biometric scanners. It is preferred that any interaction initiating in the identity verification mechanisms at the barrier location or, in the web application or mobile device application, are recorded and automatically updated in the databases through the servers as well as any of the devices owned by the users involved in this interaction. This interaction information allows for accurate auditing of access history for highly restricted areas. Preferably, phone numbers can be used to identify users for database purposes. Preferably, the key emission process can be initiated by a request from the visitor or by the user granting an authorization. It is preferred that administrators can authorize people as controlling users of a specific area, monitor the barriers and the user activity of the restricted area, suspend or grant privileges and keys of controlling users, visitors and temporary users. The preferred operation of the device includes closing control loop sensors such as but not limited to proximity, hall-effect, optical, and inductive sensors.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed:

1. A barrier control system comprising:
at least one processor;
at least one memory modules;
at least one transceiver module;
a plurality of ports;
wherein at least one port of said plurality of ports is dedicated to interface with an access gate for a restricted area;
wherein at least one port of said plurality of ports is dedicated to interface with a digital key input device;
wherein said at least one processor is configured to receive a digital key input data, send it to a remote server through said at least one transceiver module, and receive authorization data related to said digital key input data; and
wherein said at least one processor is further configured to send a grant or deny access command to said access gate for a restricted area based on said received authorization data.

2. The barrier control system of claim 1, wherein said at least one transceiver module is a Wi-Fi module.

3. The barrier control system of claim 1, wherein said digital key input device is a barcode scanner.

4. The barrier control system of claim 1, wherein said digital key input device is a QR code scanner.

5. The barrier control system of claim 1, wherein said digital key input device is a fingerprint scanner.

6. The barrier control system of claim 1, wherein said digital key input device is a camera.

7. The barrier control system of claim 1, wherein said at least one processor is further configured to identify facial features through image recognition software.

8. The barrier control system of claim 1, wherein said digital key input device is an RFID reader.

9. The barrier control system of claim 1, wherein data related to access granted and denied is stored in a database in said remote server.

10. The barrier control system of claim 1, wherein said at least one memory modules comprises digital key data configuration software.

11. The barrier control system of claim 10, wherein said digital key data configuration software is accessible through a web application.

12. The barrier control system of claim 10, wherein said digital key data configuration software is accessible through a mobile application.
